(19) United States
(12) Patent Application Publication
(10) Pub. No.: US 2023/0063888 A1
(43) Pub. Date: Mar. 2, 2023

(54) Fabric Conditioning Compositions Including Highly Branched Cyclic Dextrin and Methods for Using the Same

(71) Applicant: Henkel IP & Holding GmbH, Duesseldorf (DE)

(72) Inventors: Joseph D. Dahlmeyer, JR., East Haven, CT (US); David Anthony Reagan, Ansonia, CT (US); Daniel Thomas Piorkowski, Fairfield, CT (US)

(73) Assignee: Henkel IP & Holding GmbH, Duesseldorf (DE)

(21) Appl. No.: 17/445,783

(22) Filed: Aug. 24, 2021

(51) Int. Cl. C11D 3/00; C11D 11/00; C11D 3/22; C11D 3/30; C11D 3/37; D06L 1/16

(52) U.S. Cl. CPC C11D 3/0015; C11D 11/0017; C11D 3/222; C11D 3/30; C11D 3/37; D06L 1/16

(57) ABSTRACT

A fabric conditioning composition includes a fabric softening agent, a highly-branched cyclic dextrin, and water. A method for laundering fabric includes applying a detergent composition to the fabric, rinsing the detergent composition from the fabric, and after rinsing the detergent composition from the fabric, applying a fabric conditioning composition to the fabric. The fabric conditioning composition includes a fabric softening agent, a highly-branched cyclic dextrin, and water. Furthermore, the method includes rinsing the fabric conditioning composition from the fabric.

### FIELD OF THE INVENTION

The present disclosure generally relates to field of laundry washing and care compositions and uses thereof. More particularly, the present disclosure relates to fabric conditioning compositions including highly-branched cyclic dextrin as a malodor control agent and methods for using the same.

### BACKGROUND OF THE INVENTION

Fabrics can become hard due to repeated washings. Also, after washing, fabrics can have an undesirable smell. To restore their softness, improve their scent, or impart other desirable properties, fabrics are often treated by additional processes that are separate from their washing. The treatments are separate because the fabric-treating compositions are often not compatible with the washing detergent. These additional processes can be done, for example, in the washer during an added cycle, or in the dryer when using a solid composition. For example, it is well known to provide liquid fabric conditioning compositions that soften washed fabrics. Such compositions are typically added to the fabrics in the rinse cycle of the wash process.

Body odor is one of the most prevalent malodors that consumers seek to address by laundering with various detergents, and also using the fabric conditioning compositions noted above. The chemical constituents within body odor, predominantly short-chained fatty acids and mercaptans, persist on fabrics post-wear and may sometimes continue to be perceivable after washing with conventional laundry products.

It would therefore be desirable to identify new approaches to further neutralize these malodors to provide the consumers with an enhanced laundering outcome. Such approaches would desirably be incorporated within existing products used during the wash process, such as fabric conditioning compositions. These and other desirable features and characteristics will become apparent from the subsequent detailed description and the appended claims, taken in conjunction with the accompanying drawings and this background section.

### BRIEF SUMMARY OF THE INVENTION

The inventors herein have surprisingly discovered that adding amounts of highly-branched cyclic dextrin compounds to fabric conditioning compositions reduces or eliminates the perception of malodors within washed fabrics. Accordingly, in one exemplary embodiment, disclosed herein is a fabric conditioning composition including a fabric softening agent, a highly-branched cyclic dextrin, and water.

In another exemplary embodiment, disclosed herein is a method for laundering fabric including applying a detergent composition to the fabric, rinsing the detergent composition from the fabric, and after rinsing the detergent composition from the fabric, applying a fabric conditioning composition to the fabric. The fabric conditioning composition includes a fabric softening agent, a highly-branched cyclic dextrin, and water. Furthermore, the method includes rinsing the fabric conditioning composition from the fabric.

In yet another exemplary embodiment, disclosed herein is a fabric conditioning composition including a fabric softening agent including a quaternary ammonium ester compound in an amount of about 4.0 wt.-% to about 15.0 wt.-%, a highly-branched cyclic dextrin having an average molecular weight of about 500 Daltons to about 3000 kilo Daltons in an amount of about 2.0 wt.-% to about 4.0 wt.-%, and water in an amount of about 85 wt.-% to about 92 wt.-%.

This brief summary is provided to describe select concepts in a simplified form that are further described in the detailed description. Moreover, this brief summary is not intended to identify any key or essential features of the claimed subject matter, nor is it intended to be used as an aid in determining the scope of the claimed subject matter.

### BRIEF DESCRIPTION OF THE DRAWING

The present disclosure will hereinafter be described in conjunction with the following drawing FIGURE, wherein like numerals denote like elements, and wherein:

FIG. 1 is process illustration for the preparation of highly-branched cyclic dextrin from amylose.

### DETAILED DESCRIPTION OF THE INVENTION

The following detailed description is merely exemplary in nature and is not intended to limit the instant methods or compositions. Furthermore, there is no intention to be bound by any theory presented in the preceding background or the following detailed description.

Embodiments of the present disclosure are generally directed to fabric conditioning compositions including highly-branched cyclic dextrin as a malodor control agent and methods for using the same. As initially noted, body odor is one of the most prevalent malodors that consumers seek to avoid having remain on their fabrics post-wear and to remove from fabrics with various laundering agents. Such malodors are predominantly short-chain fatty acid compounds and mercaptan compounds. The fabric conditioning compositions of the present disclosure include highly-branched cyclic dextrin compounds in certain amounts, which have been discovered to be highly-effective in removing or eliminating the perception of these malodors within washed fabrics. Various exemplary embodiments of fabric conditioning compositions within the scope of the present disclosure are described below with respect to their constituent components, as follows:

### Highly-Branched Cyclic Dextrin

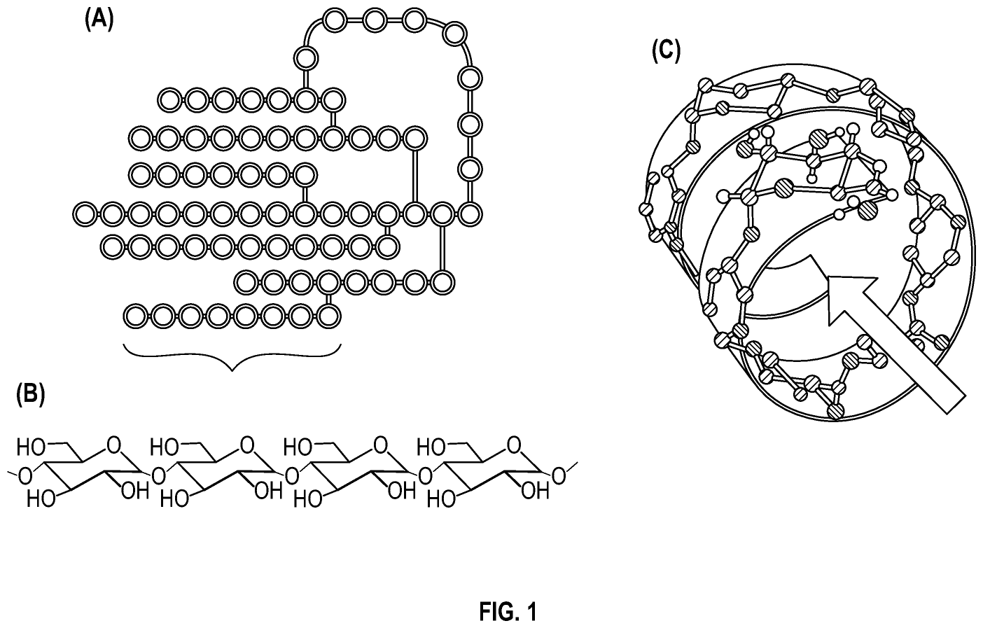

Referring to FIG. 1, dextrin is a polymer of glucose and is produced by a method of enzymatically decomposing a starch, such as amylopectin (for example corn starch). Depending on the enzyme treatment conditions in the manufacturing process, for example, the type and amount of the enzyme, the degree and form of decomposition may be manipulated to produce certain forms, such as branching and molecular weight, of dextrin. Highly-branched cyclic dextrin is one form of dextrin that may be produced in this manner (see portion “A” of FIG. 1), using a cyclization reaction of a branching enzyme (BE,1,4-α-D-glucan: 1,4-α-D-glucan 6-α-D-(1,4-α-D-glucano)-transferase, EC 2.4.1.18). Cyclic dextrin is dextrin characterized in that 6 to 16 glucoses are linked by alpha-1,4 bonds (see portion “B” of FIG. 1). One example of a cyclic dextrin is alpha-cyclodextrin, which contains six glucoses. In another example, beta-cyclodextrin contains seven glucoses, and in another example, gamma-cyclodextrin contains eight glucoses. Cyclic dextrin is further characterized in that it is shaped in the form of coil (see portion “C” of FIG. 1). Commercially available highly-branched cyclic dextrin is in the form of a white powder, is soluble in water, and has a loss on drying of less than about 5.5%.

The bonds between the glucoses allow cyclic dextrin to have the coil-like structure shown in FIG. 1, containing a certain volume of void space. The array of each interior space is formed by oxygen atoms that form glycoside bridges with hydrogen atoms. Therefore, the inner surface becomes very hydrophobic, and the specific shape and physico-chemical properties of the voids have structural features capable of absorbing organic molecules or portions of organic molecules that match the shape of the inner space of the cyclic dextrin. The outside of the cyclic dextrin, however, remains hydrophilic. In this manner, malodors may be entrained within the voids, and effectively removed when the cyclic dextrin is rinsed using water from its application site, such as a fabric. Additionally, in the same manner, malodors may be inhibited in fabrics post-wear.

The highly-branched cyclic dextrin compounds employed as a fabric malodor removal/inhibition agent may have an average molecular weight, in embodiments, from about 100 kilo Daltons to about 5000 kilo Daltons, for example from about 500 kilo Daltons to about 3000 kilo Daltons. Moreover, the highly-branched cyclic dextrin compounds may be included within the fabric conditioning composition of the present disclosure, in embodiments, in an amount of about 1.0 wt.-% to about 8.0 wt.-%, such as about 1.5 wt.-% to about 6.0 wt.-%, or about 2.0 wt.-% to about 4.0 wt.-% (all weight percentages used herein are by total weight of the fabric conditioning composition, unless otherwise specifically noted). In a particular embodiment, the highly-branched cyclic dextrin is included within the fabric conditioning composition in an amount of about 2.5 wt.-%.

### Fabric Softening Agent

In order to effect the described fabric softening properties, the fabric conditioning compositions of the present disclosure include at least one fabric softening agent. In many embodiments, the fabric softening agent is a cationic softening agent. The cationic softening is generally one that is able to form a lamellar phase dispersion in water, in particular a dispersion of liposomes. The cationic softening agent is typically a quaternary ammonium ester compound. Suitable quaternary ammonium ester compounds may include materials selected from a monoester quaternary material (“monoester quats”), diester quaternary material (“diester quats”), triester quaternary material (“triester quats”), and mixtures thereof.

Suitable quaternary ammonium ester compounds may be derived from alkanolamines, for example, C₁-C₄ alkanolamines, preferably C₂ alkanolamines (e.g., ethanolamines). The quaternary ammonium ester compounds may be derived from monoalkanolamines, dialkanolamines, trialkanolamines, or mixtures thereof, for example monoethanolamines, diethanolamines, di-isopropanolamines, triethanolamines, or mixtures thereof. The quaternary ammonium ester compounds may be derived from diethanolamines. The quaternary ammonium ester compounds may be derived from di-isopropanolamines. The quaternary ammonium ester compounds may be derived from triethanolamines. The alkanolamines from which the quaternary ammonium ester compounds are derived may be alkylated mono- or dialkanolamines, for example C₁-C₄ alkylated alkanolamines, for example C₁ alkylated alkanolamines (e.g., N-methyl di ethanol amine).

The quaternary ammonium ester compound may include a quaternized nitrogen atom that is substituted, at least in part. The quaternized nitrogen atom may be substituted, at least in part, with one or more C₁-C₃ alkyl or C₁-C₃ hydroxyl alkyl groups. The quaternized nitrogen atom may be substituted, at least in part, with a moiety selected from the group consisting of methyl, ethyl, propyl, hydroxyethyl, 2-hydroxypropyl, 1-methyl-2-hydroxyethyl, poly(C₂-C₃ alkoxy), polyethoxy, benzyl, for example methyl or hydroxyethyl.

The quaternary ammonium ester compound may include compounds according to Formula (I):

{R²₍₄₋ₘ₎—N+-[X—Y—R¹]ₘ}A⁻ Formula (I)

wherein:

m is 1, 2 or 3, with provisos that, in a given molecule, the value of each m is identical;

each R¹, which may include from 13 to 22 carbon atoms, is independently a linear hydrocarbyl or branched hydrocarbyl group. R¹ may be linear, such as a partially-unsaturated linear alkyl chain;

each R² is independently a C₁-C₃ alkyl or hydroxyalkyl group and/or each R² is selected from methyl, ethyl, propyl, hydroxyethyl, 2-hydroxypropyl, 1-methyl hydroxyethyl, poly(C₂-C₃ alkoxy), polyethoxy, benzyl, for example methyl or hydroxyethyl;

each X is independently —(CH₂)ₙ—, —CH₂—CH(CH₃)—, or —CH(CH₃)—CH₂—, where each n is independently 1, 2, 3 or 4, for example each n may be 2;

each Y is independently —O—(O)C— or —C(O)—O—; and

A⁻ is independently selected from the group of chloride, bromide, methyl sulfate, ethyl sulfate, sulfate, and nitrate, for example A⁻ is selected from the group of chloride and methyl sulfate, such as methyl sulfate.

The fabric softening agent may be included within the fabric conditioning compositions of the present disclosure, in embodiments, in an amount of about 4.0 wt.-% to about 15.0 wt.-%, such as about 6.0 wt.-% to about 12.0 wt.-%, or about 7.0 wt.-% to about 9.0 wt.-%. In a particular embodiment, the softening agent may be included within the fabric conditioning composition in an amount of about 8.0 wt.-%.

### Aqueous Base

The fabric conditioning compositions of the present disclosure include water, as a base solvent, in an amount of about 75 wt.-% to about 95 wt.-%, such as about 85 wt.-% to about 92 wt.-%. In a particular embodiment, water may be included within the fabric conditioning composition in an amount of about 8.0 wt.-%.

The aqueous base may also include water-soluble species, such as mineral salts or short chain (C₁₋₄) alcohols. The mineral salts may aid the attainment of the desired phase volume for the composition. Such salts may be present in an amount of about 0.001 to about 1%, such as from about 0.005 wt.-% to about 0.1 wt.-%. Examples of suitable mineral salts for this purpose include calcium chloride and magnesium chloride. Examples of suitable short chain alcohols include primary alcohols, such as ethanol, propanol, and butanol, secondary, alcohols such as isopropanol, and polyhydric alcohols such as propylene glycol and glycerol.

### Rheology Polymer

The fabric conditioning compositions of the present disclosure may include a rheology polymer or “thickener”. The rheology polymer promotes a desired thick and creamy appearance of the fabric conditioning compositions. The molecular weight of the rheology polymer may be from about 1,000 Daltons to about 1,000,000 Daltons, such as from about 50,000 Daltons to about 500,000 Daltons, or about 100,000 Daltons to about 400,000 Daltons. The rheology polymer may be present in an amount of at least about 0.0005 wt.-%, such as from about 0.0005 wt.-% to about 2 wt.-%, or about 0.001 wt.-% to about 0.5 wt.-%.

Suitable rheology polymers may be selected from hydrophobically modified cellulose ethers. Such materials are typically nonionic polymers and have a sufficient degree of nonionic substitution selected from the class consisting of methyl, hydroxyethyl and hydroxypropyl to cause them to be water-soluble and which are further substituted with one or more hydrocarbon radicals having from 10 to 24 carbon atoms. The nonionic cellulose ether that forms the backbone of the hydrophobically modified derivative may be any nonionic water soluble cellulose ether substrate, such as hydroxyethyl cellulose (HEC), hydroxypropyl cellulose (HPC), methyl cellulose, hydroxypropyl methyl cellulose; ethyl hydroxyethyl cellulose or methyl hydroxyethyl cellulose.

### Further Optional Ingredients

The fabric conditioning compositions of the present disclosure may optionally include one or more other ingredients. Such ingredients include co-softeners (such as fatty esters, and fatty N-oxides) preservatives (e.g. bactericides), pH buffering agents, perfumes, perfume carriers, fluorescers, colorants, hydrotropes, antifoaming agents, anti-redeposition agents, soil-release agents, polyelectrolytes, enzymes, optical brightening agents, anti-shrinking agents, anti-wrinkle agents, anti-spotting agents, anti-oxidants, sunscreens, anti-corrosion agents, drape imparting agents, anti-static agents, ironing aids, and dyes, among others known in the art. Such optional ingredients may be included in amounts, respectively, of from about 0.0001 wt.-% to about 1.0 wt.-%, for example. Additionally, as fabric conditioning compositions, embodiments of the present disclosure may exclude certain compounds that are commonly found in detergent compositions. These excluded compounds include, for example, cationic water-soluble polymers, non-ionic surfactants, and/or tertiary amine compounds.

### Product Use/Manufacture

The fabric conditioning compositions of the present disclosure may be rinse conditioner compositions and may be used in the rinse cycle of a domestic laundry process. The compositions may be used in the rinse cycle of a home fabric laundering operation, where, it may be added directly in an undiluted state to a washing machine, e.g. through a dispenser drawer or, for a top-loading washing machine, directly into the drum. Alternatively, it may be diluted prior to use. The compositions may also be used in a domestic hand-washing laundry operation. It is also possible for the compositions of the present invention to be used in industrial laundry operations.

The fabric conditioning compositions of the present disclosure may be manufactured by combining the various ingredients together and then performing a mixing operation. The mixing operation may be shear mixing, in an embodiment.

### Illustrative Examples

The present disclosure is now illustrated by the following non-limiting examples. It should be noted that various changes and modifications may be applied to the following examples and processes without departing from the scope of this invention, which is defined in the appended claims. Therefore, it should be noted that the following examples should be interpreted as illustrative only and not limiting in any sense.

The illustrative examples presented herein demonstrate the effect of post-wear reduction in the perception of malodor using compositions of the present disclosure as compared with conventional fabric conditioning compositions. Accordingly, a fabric conditioning composition in accordance with the present disclosure (“Example”) and a comparative fabric conditioning composition (having the highly-branched cyclic dextrin not present) (“Comparison”) are provided in TABLES 1 and 2, respectively, below:

TABLE 1

| Ingredient | Active Wt.-% |
|---|---|
| Deionized Water | 89.35 |
| Rheology Polymer | 0.02 |
| Diester Quat Softening Agent | 8 |
| Calcium Chloride | 0.007 |
| Lactic Acid | 0.05 |
| Glutaraldehyde | 0.07 |
| Highly-Branched Cyclic Dextrin | 2.5 |
| Total | 100 |

TABLE 2

| Ingredient | Active Wt.-% |
|---|---|
| Deionized Water | 91.85 |
| Rheology Polymer | 0.02 |
| Diester Quat Softening Agent | 8 |
| Calcium Chloride | 0.007 |
| Lactic Acid | 0.05 |
| Glutaraldehyde | 0.07 |
| Total | 100 |

### Fabric Treatment Protocol

A 1500 mL beaker was charged with 1000 mL of deionized water. The beaker was equipped with a stir blade and the mixer was set to 205 rpm. 1.69 g of the respective formulation (Exemplary or Comparative) was added to the deionized water and was mixed for 1 minute. 20 2×2 inch 100% knit cotton swatches were added to each beaker and were mixed for 15 minutes. The fabrics were removed from the beaker with clean gloves and were squeezed to remove excess water. The fabrics were unfolded, placed flat onto a drying rack and were air dried overnight at room temperature.

Thereafter, each 2×2 inch swatch was draped over a 50 mL beaker. 100 μL of four different body odor compositions (butyric acid, octanoic acid, isovaleric acid, and 3-mercapto-2-methylpentan-1-ol) was spiked onto each swatch. After spiking, 10 minutes lapsed for solvent evaporation, and the swatches were transferred to clean 20 mL glass vials for analysis using dynamic headspace and gas chromatography coupled to mass spectrometry (DHS GCMS). DHS GCMS functions to extract and concentrate volatile organic compounds (VOCs) from liquid or solid samples, and to thereafter analyze the amount and composition of the VOCs thus extracted. The DHS GCMS experiment was then run, and the results therefrom analyzed using statistical analysis.

The statistical analysis employed in connection with the present illustrative examples was analysis of variance (ANOVA). ANOVA is a well-known statistical model used to analyze the differences among means, in this case the means of the DHS GCMS results pertaining to the amount of VOCs (i.e., the body odor compositions) detected in the respective Example and Comparative fabric samples. Using ANOVA, a statistical difference between means (i.e., that the observed VOC values from the Example swatches was less than the observed VOC values from the Comparative swatches) is demonstrated when the calculated p-value is less than 0.05. As a result of the DHS GCMS testing, and subsequent ANOVA, TABLE 3, below, presents to calculated p-values for each body odor composition tested.

TABLE 3

| Body Odor Composition | p-value |
|---|---|
| Butyric Acid | 0.0001 |
| Octanoic Acid | <0.0001 |
| Isovaleric Acid | 0.0109 |
| 3-mercapto-2-methylpentan-1-ol | 0.0031 |

As demonstrated in the data presented in TABLE 3, the p-values associated with the DHS GCMS testing are significantly below the confidence threshold of 0.05, meaning that the body odor VOCs extracted from the Example swatches was statistically significantly less than the body odor VOCs extracted from the Comparison swatches. This demonstrates that in post-wear applications, the compositions for the present disclosure effectively function to reduce the amount of body odor perceptible on fabrics.

Accordingly, the present disclosure has provided fabric conditioning compositions that include highly-branched cyclic dextrin as a malodor control agent. In the disclosed compositions, the highly-branched cyclic dextrin compounds have been discovered and demonstrated to be highly-effective in removing or eliminating the perception of these malodors within washed fabrics.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

1. A fabric conditioning composition comprising:
a fabric softening agent;
a highly-branched cyclic dextrin, wherein the highly-branched cyclic dextrin is shaped in the form of a coil, and wherein the highly-branched cyclic dextrin is present in the fabric conditioning composition in an amount of from about 1.0 wt.-% to about 8.0 wt.-%, based on a total weight of the fabric conditioning composition; and
water.

2. The fabric conditioning composition of claim 1, wherein the highly-branched cyclic dextrin has an average molecular weight of about 100 Daltons to about 5000 kilo Daltons.

3. The fabric conditioning composition of claim 2, wherein the highly-branched cyclic dextrin has an average molecular weight of about 500 Daltons to about 3000 kilo Daltons.

4. The fabric conditioning composition of claim 1, wherein the highly-branched cyclic dextrin is present in the fabric conditioning composition in an amount of about 2.5 wt.-%, based on the total weight of the fabric conditioning composition.

5. The fabric conditioning composition of claim 1, wherein the highly-branched cyclic dextrin is present in the fabric conditioning composition in an amount of about 2.0 wt.-% to about 4.0 wt.-%, based on the total weight of the fabric conditioning composition.

6. The fabric conditioning composition of claim 1, wherein the fabric softening agent comprises a quaternary ammonium ester compound.

7. The fabric conditioning composition of claim 6, wherein the fabric softening agent is present in the fabric conditioning composition in an amount of about 4.0 wt.-% to about 15.0 wt.-%, based on the total weight of the fabric conditioning composition.

8. The fabric conditioning composition of claim 1, wherein the water is present in the fabric conditioning composition in an amount of about 75 wt.-% to about 95 wt.-%, based on the total weight of the fabric conditioning composition.

9. The fabric conditioning composition of claim 1, further comprising a rheology polymer.

10. The fabric conditioning composition of claim 9, wherein the rheology polymer is present in the fabric conditioning composition in an amount of about 0.001 wt.-% to about 0.5 wt.-%, based on the total weight of the fabric conditioning composition.

11. A method for laundering fabric, comprising:
applying a detergent composition to the fabric;
rinsing the detergent composition from the fabric;
after rinsing the detergent composition from the fabric, applying a fabric conditioning composition to the fabric, wherein the fabric conditioning composition comprises a fabric softening agent, a highly-branched cyclic dextrin, and water, wherein the highly-branched cyclic dextrin is shaped in the form of a coil, and wherein the highly-branched cyclic dextrin is present in the fabric conditioning composition in an amount of from about 1.0 wt.-% to about 8.0 wt.-%, based on a total weight of the fabric conditioning composition; and
rinsing the fabric conditioning composition from the fabric.

12. The method of claim 11, wherein in the fabric conditioning composition, the highly-branched cyclic dextrin has an average molecular weight of about 100 Daltons to about 5000 kilo Daltons.

13. The method of claim 12, wherein in the fabric conditioning composition, the highly-branched cyclic dextrin has an average molecular weight of about 500 Daltons to about 3000 kilo Daltons.

14. The method of claim 11, wherein in the fabric conditioning composition, the highly-branched cyclic dextrin is present in the fabric conditioning composition in an amount of about 2.5 wt.-%, based on the total weight of the fabric conditioning composition.

15. The method of claim 14, wherein in the fabric conditioning composition, the highly-branched cyclic dextrin is present in the fabric conditioning composition in an amount of about 2.0 wt.-% to about 4.0 wt.-%, based on the total weight of the fabric conditioning composition.

16. The method of claim 11, wherein in the fabric conditioning composition, the fabric softening agent comprises a quaternary ammonium ester compound.

17. The method of claim 16, wherein in the fabric conditioning composition, the fabric softening agent is present in the fabric conditioning composition in an amount of about 4.0 wt.-% to about 15.0 wt.-%, based on the total weight of the fabric conditioning composition.

18. The method of claim 11, wherein in the fabric conditioning composition, the water is present in the fabric conditioning composition in an amount of about 75 wt.-% to about 95 wt.-%, based on the total weight of the fabric conditioning composition.

19. The method of claim 11, further comprising a rheology polymer in the fabric conditioning composition in an amount of about 0.001 wt.-% to about 0.5 wt.-% based on the total weight of the fabric conditioning composition.

20. A fabric conditioning composition comprising:
a fabric softening agent comprising a quaternary ammonium ester compound in an amount of about 4.0 wt.-% to about 15.0 wt.-%, based on a total weight of the fabric conditioning composition;
a highly-branched cyclic dextrin having an average molecular weight of about 500 Daltons to about 3000 kilo Daltons in an amount of about 2.0 wt.-% to about 4.0 wt.-%, based on the total weight of the fabric conditioning composition, wherein the highly-branched cyclic dextrin is shaped in the form of a coil; and
water in an amount of about 85 wt.-% to about 92 wt.-%, based on the total weight of the fabric conditioning composition.
